(19) United States
(12) Patent Application Publication
(10) Pub. No.: US 2021/0240211 A1
(43) Pub. Date: Aug. 5, 2021

(54) LINEAR POWER REGULATOR TO PREVENT EXCESSIVE INRUSH CURRENT

(71) Applicant: ELECTRONICS AND TELECOMMUNICATIONS RESEARCH INSTITUTE, Daejeon (KR)

(72) Inventor: Seunghyun JANG, Daejeon (KR)

(21) Appl. No.: 17/155,306

(22) Filed: Jan. 22, 2021

(30) Foreign Application Priority Data
Jan. 30, 2020 (KR) 10-2020-0011078

(51) Int. Cl. G05F 1/569; G05F 1/595; G05F 1/575

(52) U.S. Cl. CPC G05F 1/569; G05F 1/575; G05F 1/595

(57) ABSTRACT

The linear power regulator includes a source follower configured to determine an output voltage of the linear power regulator based on a reference voltage signal applied from outside, a pass-transistor connected to a source end of the source follower and configured to provide a current to a load of the linear power regulator, a negative feedback loop formed by connecting a drain terminal of the source follower and a gate of the pass-transistor, and a negative feedback coefficient controller disposed between the drain terminal of the source follower and the gate of the pass-transistor, and configured to control a negative feedback coefficient of the negative feedback loop by changing the negative feedback coefficient of the negative feedback loop based on an elapsed time from a point in time at which a power signal is applied to the linear power regulator.

### CROSS-REFERENCE TO RELATED APPLICATION(S)

This application claims the priority benefit of Korean Patent Application No. 10-2020-0011078 filed on Jan. 30, 2020, in the Korean Intellectual Property Office, the disclosure of which is incorporated herein by reference for all purposes.

### BACKGROUND

### 1. Field of the Invention

One or more example embodiments relate to a linear power regulator, and more particularly, to a linear power regulator that prevents an excessive inrush current from being input to a load end.

### 2. Description of Related Art

Power management of mobile devices and communication networks has more integrated into mobile home appliances and Internet of things (IoT) devices. There has been ongoing research at various levels to find a way to improve power efficiency and battery life.

For example, a system on a chip (SoC) in which various circuits are integrated generally uses all analog, digital, and mixed-signal circuit blocks, and thus uses a plurality of linear power regulators for stable yet higher circuit performance.

Recently, a flipped voltage follower (FVF)-based linear power regulator is attracting a great deal of interest because it has a fast response characteristic and is embodied as a small chip and is thus effective in integration, compared to other output capacitor-less linear power regulators.

An existing FVF-based linear power regulator may regulate an output signal V_{OUT} of an FVF circuit to have the same value as an input reference voltage signal V_{REF} through a negative feedback operation. However, the FVF-based linear power regulator may operate unstably immediately when power is applied.

Particularly, an inrush current that is generated to rapidly charge a capacitor present in a load of the regulator when power is applied may be extremely higher than a current in a normal state, and thus may damage the capacitor present at a load end. This may cause performance degradation and malfunction of a chip, compromising the reliability.

Thus, there is a need for a linear power regulator that may prevent an excessive inrush current.

### SUMMARY

An aspect provides a linear power regulator that reduces an inrush current flowing in a pass-transistor and a load end when power is applied, thereby preventing a malfunction of a circuit and damage to the circuit.

Another aspect provides a linear power regulator that reduces an inrush current by controlling a negative feedback coefficient by a negative feedback coefficient controller of a simple structure, thereby minimizing the size of an area of a chip including the linear power regulator.

According to an example embodiment, there is provided a linear power regulator including a source follower configured to determine an output voltage of the linear power regulator based on a reference voltage signal applied from outside, a pass-transistor connected to a source end of the source follower and configured to provide a current to a load of the linear power regulator, a negative feedback loop formed by connecting a drain terminal of the source follower and a gate of the pass-transistor, and a negative feedback coefficient controller disposed between the drain terminal of the source follower and the gate of the pass-transistor and configured to control a negative feedback coefficient of the negative feedback loop. The negative feedback coefficient controller may change the negative feedback coefficient of the negative feedback loop based on an elapsed time from a point in time at which a power signal is applied to the linear power regulator.

The negative feedback coefficient controller may control the negative feedback coefficient to be less than a steady-state negative feedback coefficient for a predetermined period of time from the point in time at which the power signal is applied to the linear power regulator.

The negative feedback coefficient controller may include a transmission gate switch configured to be switched on or off based on a control signal and change an impedance at both ends of the transmission gate switch by being switched on or off to control the negative feedback coefficient.

The linear power regulator may further include a control signal generator configured to receive the power signal that is applied or a driving signal that drives the linear power regulator, and output a control signal for controlling the negative feedback coefficient based on a point in time at which the power signal or the driving signal is received. The negative feedback coefficient controller may control the negative feedback coefficient based on the control signal.

The control signal generator may include a delay circuit configured to delay the power signal or the driving signal for a predetermined period of time, and then input the delayed power signal or the delayed driving signal to the negative feedback coefficient controller to control the negative feedback coefficient to be maintained less than the steady-state negative feedback coefficient for the predetermined period of time.

The control signal generator may include a ramp generating circuit configured to generate a ramp signal-type control signal based on the driving signal. The ramp signal-type control signal may control the negative feedback coefficient to increase at a speed less than or equal to a preset speed.

The control signal generator may include an input power-based ramp generating circuit configured to generate a control signal that increases at a speed less than or equal to a preset speed when the power signal is applied.

When the driving signal is received, the input power-based ramp generating circuit may convert the driving signal to the power signal by removing a switch for ENABLE from the driving signal.

According to another example embodiment, there is provided a linear power regulator including a first source follower configured to determine an output voltage of the linear power regulator based on a reference voltage signal applied from outside, a pass-transistor connected to a source end of the first source follower and configured to provide a current to a load of the linear power regulator, a second source follower connected to a drain terminal of the first source follower and a gate of the pass-transistor to form a negative feedback loop, and a negative feedback coefficient controller configured to control a negative feedback coefficient of the negative feedback loop. The negative feedback coefficient controller may change the negative feedback coefficient of the negative feedback loop based on an elapsed time from a point in time at which a power signal is applied to the linear power regulator.

The negative feedback coefficient controller may control the negative feedback coefficient to be less than a steady-state negative feedback coefficient for a predetermined period of time from the point in time at which the power signal is applied to the linear power regulator.

The negative feedback coefficient controller may include a transmission gate switch configured to be switched on off based on a control signal, and change an impedance at both ends of the transmission gate switch by being switched on or off to control the negative feedback coefficient.

According to still another example embodiment, there is provided a linear power regulator including a source follower configured to determine an output voltage of the linear power regulator based on a reference voltage signal applied from outside, a pass-transistor connected to a source end of the source follower and configured to provide a current to a load of the linear power regulator, a cascode transistor connected to a drain terminal of the source follower and a gate of the pass-transistor to form a negative feedback loop, and a negative feedback coefficient controller disposed between the cascode transistor and the pass-transistor and configured to control a negative feedback coefficient of the negative feedback loop. The negative feedback coefficient controller may change the negative feedback coefficient of the negative feedback loop based on an elapsed time from a point in time at which a power signal is applied to the linear power regulator.

The negative feedback coefficient controller may control the negative feedback coefficient to be less than a steady-state negative feedback coefficient for a predetermined period of time from the point in time at which the power signal is applied to the linear power regulator.

The negative feedback coefficient controller may include a transmission gate switch configured to be switched on or off based on a control signal and change an impedance at both ends of the transmission gate switch by being switched on or off to control the negative feedback coefficient.

According to yet another example embodiment, there is provided a linear power regulator including a first source follower configured to determine an output voltage of the linear power regulator based on a reference voltage signal applied from outside, a pass-transistor connected to a source end of the first source follower and configured to provide a current to a load of the linear power regulator, a second source follower different from the first source follower, a local negative feedback loop including a common source amplifier, a main negative feedback loop formed by connecting a drain terminal of the first source follower, a gate of the pass-transistor, and the local negative feedback loop, and a negative feedback coefficient controller disposed in the main negative feedback loop and configured to control a negative feedback coefficient of the main negative feedback loop. The negative feedback coefficient controller may change the negative feedback coefficient of the main negative feedback loop based on an elapsed time from a point in time at which a power signal is applied to the linear power regulator.

The negative feedback coefficient controller may control the negative feedback coefficient to be less than a steady-state negative feedback coefficient for a predetermined period of time from the point in time at which the power signal is applied to the linear power regulator.

The negative feedback coefficient controller may include a transmission gate switch configured to be switched on or off based on a control signal and change an impedance at both ends of the transmission gate switch by being switched on or off to control the negative feedback coefficient.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of a linear power regulator according to an example embodiment;

FIG. 2 is a diagram illustrating an example of a linear power regulator according to another example embodiment;

FIG. 3 is a diagram illustrating an example of a linear power regulator according to another example embodiment;

FIG. 4 is a diagram illustrating an example of a linear power regulator according to another example embodiment;

FIG. 5 is a diagram illustrating an example of a result of a simulation of a linear power regulator according to an example embodiment;

FIG. 6 is a diagram illustrating an example of a linear power regulator according to another example embodiment;

FIG. 7 is a diagram illustrating an example of a linear power regulator according to another example embodiment; and

FIG. 8 is a diagram illustrating an example of a linear power regulator according to another example embodiment.

### DETAILED DESCRIPTION

Hereinafter, some examples will be described in detail with reference to the accompanying drawings. However, various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

When describing the examples with reference to the accompanying drawings, like reference numerals refer to like constituent elements and a repeated description related thereto will be omitted. In the description of examples, detailed description of well-known related structures or functions will be omitted when it is deemed that such description will cause ambiguous interpretation of the present disclosure.

Hereinafter, example embodiments will be described in detail with reference to the accompanying drawings.

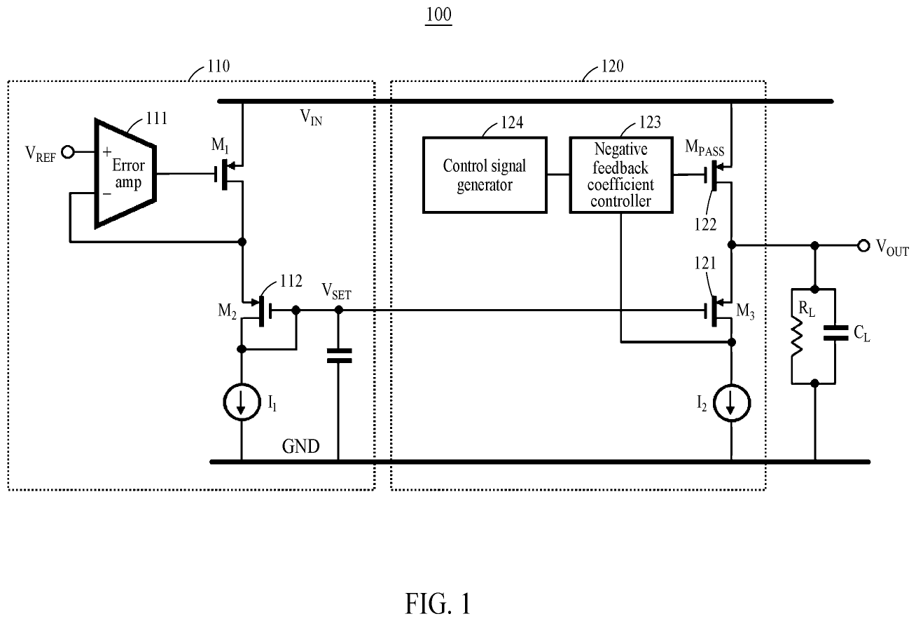

FIG. 1 is a diagram illustrating an example of a linear power regulator according to an example embodiment.

Referring to FIG. 1, a linear power regulator 100 includes a V_{SET} generating circuit 110 and a flipped voltage follower (FVF) circuit 120.

The V_{SET} generating circuit 110 may receive a reference signal V_{REF} from outside, and generate a reference voltage signal V_{SET} for determining an output voltage V_{OUT} of the linear power regulator 100.

As illustrated, the V_{SET} generating circuit 110 includes an error amplifier 111 and a reference signal source follower 112.

The error amplifier 111 may receive the reference signal V_{REF} and a source voltage of the reference signal source follower 112 to perform a negative feedback operation. The source voltage of the reference signal source follower 112 may have the same value as the reference signal V_{REF} by the negative feedback operation performed by the error amplifier 111. Thus, the source voltage of the reference signal source follower 112 may be V_{REF}, and thus a voltage V_{SET} may be determined as represented by Equation 1 below.

V_{SET}=V_{REF}=V_{SG1} [Equation 1]

In Equation 1, V_{SG1} denotes a voltage difference between both source and gate ends of the reference signal source follower 112.

The FVF circuit 120 may receive the reference voltage signal V_{SET} to provide power to an output. As illustrated in FIG. 1, The FVF circuit 120 includes a source follower 121, a pass-transistor 122, a negative feedback coefficient controller 123, and a control signal generator 124.

The source follower 121 may determine an output voltage of the linear power regulator 100 based on a reference voltage signal applied from outside. That is, the source follower 121 may determine the output voltage V_{OUT} of the linear power regulator 100 based on the reference voltage signal V_{SET} received from the V_{SET} generating circuit 110.

The pass-transistor 122 may be connected to a source end of the source follower 121, and provide a current to a load (e.g., R_{L}, C_{L}) of the linear power regulator 100.

The FVF circuit 120 may also include a negative feedback loop that is formed by connecting a drain terminal of the source follower 121 and a gate of the pass-transistor 122. The negative feedback loop may operate such that V_{OUT} is maintained consistently, and thus V_{OUT} may be represented by Equation 2 below.

V_{OUT}=V_{SET}+V_{SG3}=V_{REF}−V_{SG1}+V_{SG3} [Equation 2]

In Equation 2, V_{SG3} denotes a voltage difference between both source and gate ends of the source follower 121.

The negative feedback coefficient controller 123 may be disposed between the drain terminal of the source follower 121 and the gate of the pass-transistor 122, and control a negative feedback coefficient of the negative feedback loop. Here, a voltage V_{SG1} of the reference signal source follower 112 and a voltage V_{SG3} of the source follower 121 are design parameters. Thus, by determining the design parameters based on a voltage required for the linear power regulator 100, it is possible to allow the output voltage V_{OUT} of the linear power regulator 100 to be the voltage required for the linear power regulator 100.

The control signal generator 124 may receive a power signal (e.g., V_{IN}) that is applied or a driving signal that drives the linear power regulator 100. The driving signal may be a control signal that drives the linear power regulator 100. The driving signal may be, for example, an ENABLE (or EN) signal of the linear power regulator 100.

In addition, the control signal generator 124 may receive the power signal or output a control signal for controlling the negative feedback coefficient based on a point in time at which the driving signal is received. Here, the negative feedback coefficient controller 123 may change the negative feedback coefficient of the negative feedback loop based on an elapsed time from the point in time at which the power signal is applied to the linear power regulator 100.

For example, the control signal generator 124 may output the control signal that allows the negative feedback coefficient controller 123 to control the negative feedback coefficient to be less than a steady-state negative feedback coefficient, during a predetermined period of time from the point in time at which the power signal is applied to the linear power regulator 100.

That is, the control signal generator 124 may output the control signal that controls the negative feedback coefficient to be low at an initial stage after the power signal is applied to the linear power regulator 100 and to have the steady-state negative feedback coefficient after a predetermined period of time elapses.

During the period of time from the point in time at which the power signal is applied to the linear power regulator 100, the negative feedback coefficient controller 123 may control the negative feedback coefficient to be lower than the steady-state negative feedback coefficient based on the control signal, thereby weakening a driving force with which the pass-transistor 122 controls the output voltage. Thus, it is possible to maintain, to be small, an inrush current for rapidly charging a load capacitor C_{L} from the pass-transistor 122.

In addition, after the period of time elapses from the point in time at which the power signal is applied to the linear power regulator 100, the negative feedback coefficient controller 123 may control the negative feedback coefficient to be the steady-state negative feedback coefficient based on the control signal, and execute a steady-state negative feedback operation. Thus, the linear power regulator 100 may operate as a steady-state power regulator.

In addition, the control signal generator 124 may process the received driving signal to use it as the control signal. For example, the control signal generator 124 may include a delay circuit that delays the power signal or the driving signal for a predetermined period of time.

In such a case, the control signal generator 124 may input, to the negative feedback coefficient controller 123, the power signal or the driving signal that is delayed for the period of time as the control signal that controls the negative feedback coefficient to be the steady-state negative feedback coefficient.

The negative feedback coefficient controller 123 may receive the control signal after a predetermined period of time from a point in time at which the control signal generator 124 receives the power signal or the driving signal. Thus, even though the negative feedback coefficient controller 123 controls the negative feedback coefficient to have the steady-state negative feedback coefficient immediately at a point in time at which the negative feedback coefficient controller 123 receives the control signal, the negative feedback coefficient may be controlled to have the steady-state negative feedback coefficient after being maintained to be low for the predetermined period of time from the point in time at which the power signal is applied or the driving signal is received.

In addition, the control signal generator 124 may output the control signal by converting the power signal or the driving signal through a signal generator by which the output signal tends to increase or decrease at a speed less than or equal to a preset speed. In such a case, based on the control signal that increases or decreases at the preset or less speed, the negative feedback coefficient controller 123 may increase or decrease the negative feedback coefficient at the preset or less speed. It is thus possible to reduce an undesired voltage or a current spike, and an additional inrush current.

According to an example embodiment, the linear power regulator 100 may reduce an inrush current that flows in a pass-transistor and a load end when power is applied, thereby preventing a malfunction of a circuit and damage to the circuit.

In addition, the linear power regulator 100 may control a negative feedback coefficient of the linear power regulator 100 through a negative feedback coefficient controller of a simple structure to reduce an inrush current in the linear power regulator 100. Thus, it is possible to minimize the size of an area of a chip including the linear power regulator 100, and enable integration more effectively.

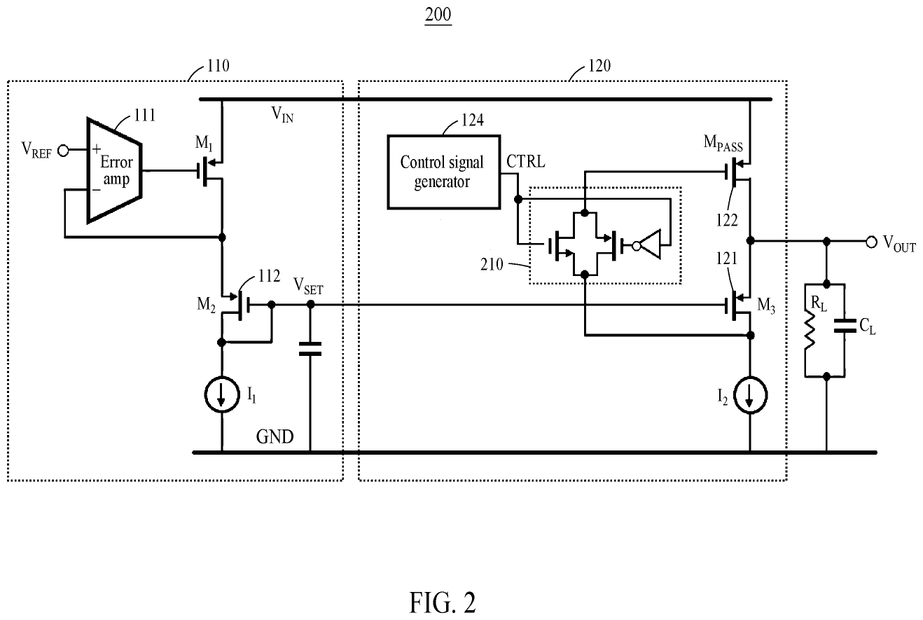

FIG. 2 is a diagram illustrating an example of a linear power regulator according to another example embodiment.

Referring to FIG. 2, a linear power regulator 200 includes a V_{SET} generating circuit 110, a source follower 121, a pass-transistor 122, and a control signal generator 124, which are the same components as described in FIG. 1, and thus a more detailed and repeated description of the components will be omitted here for brevity.

As illustrated in FIG. 2, a negative feedback coefficient controller 123 includes a transmission gate switch that is switched on or off based on a control signal received from the control signal generator 124. The control signal that switches the transmission gate switch on or off may be, for example, a CONTROL (or CTRL) signal which is an output control signal output from the control signal generator 124.

The transmission gate switch may decrease or increase an impedance at both ends thereof based on such an on or off state to control a negative feedback coefficient. The negative feedback coefficient controller 123 may then control the negative feedback coefficient to control a gain of a negative feedback loop formed by the source follower 121 at an output end and the pass-transistor 122.

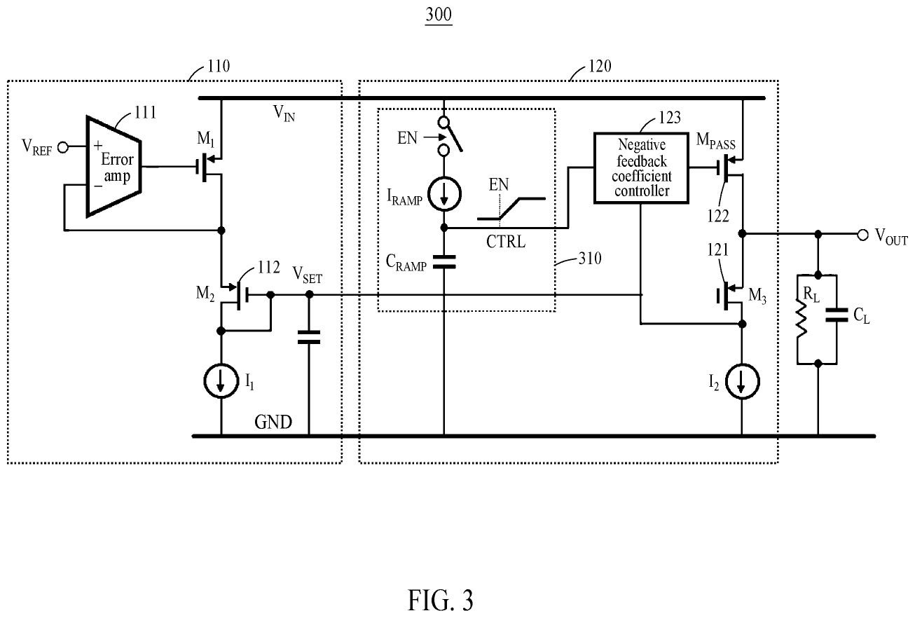

FIG. 3 is a diagram illustrating an example of a linear power regulator according to another example embodiment.

Referring to FIG. 3, a linear power regulator 300 includes a V_{SET} generating circuit 110, a source follower 121, a pass-transistor 122, and a negative feedback coefficient controller 123, which are the same components as described in FIG. 1, and thus a more detailed and repeated description of the components will be omitted here for brevity.

A control signal generator 124 may receive a power signal and process the received power signal to use it as a control signal. In such a case, the control signal generator 124 includes a ramp signal generator 310 as illustrated in FIG. 3. The ramp signal generator 310 may also be referred to herein as a ramp generating circuit 310. The ramp generating circuit 310 may generate a ramp signal-type control signal based on the power signal or a driving signal that is applied to the linear power regulator 300. The negative feedback coefficient controller 123 may then control a negative feedback coefficient to increase at a preset or less speed based on the ramp signal-type control signal received from the ramp generating circuit 310. Thus, it is possible to reduce an undesired voltage or a current spike, and an additional inrush current.

In such a case, the ramp generating circuit 310 may not need to elaborately control an output voltage level of the ramp signal-type control signal and thus be embodied to be simple. For example, the ramp generating circuit 310 may be designed to generate a ramp signal-type control signal of a level from 0V to an input power V_{IN} level.

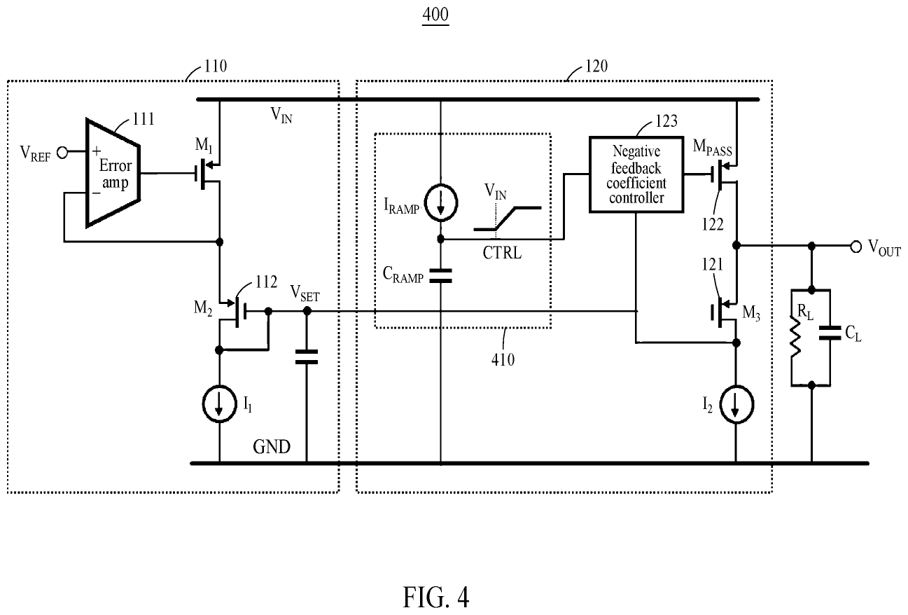

FIG. 4 is a diagram illustrating an example of a linear power regulator according to another example embodiment.

Referring to FIG. 4, a linear power regulator 400 includes a V_{SET} generating circuit 110, a source follower 121, a pass-transistor 122, and a negative feedback coefficient controller 123, which are the same components as described in FIG. 1, and thus a more detailed and repeated description of the components will be omitted here for brevity.

When a driving signal is received, a control signal generator 124 may convert it to a power signal by removing a switch for ENABLE (or an EN switch) from the driving signal. The control signal generator 124 may then apply the power signal to input power V_{IN}. In such a case, an input power-based ramp generating circuit 410 included in the control signal generator 124 may generate a ramp signal and output the generated ramp signal as a control signal. That is, the control signal generator 124 may increase a magnitude of the control signal transmitted from the input power-based ramp generating circuit 410 to the negative feedback coefficient controller 123 at a preset or less speed from a point in time at which the input power V_{IN} is applied to the linear power regulator 400. As the magnitude of the received control signal increases, the negative feedback coefficient controller 123 may also increase a negative feedback coefficient at the preset or less speed, and thus prevent an undesired voltage and a current spike, and an additional inrush current that may otherwise occur due to a rapid increase in a negative feedback gain.

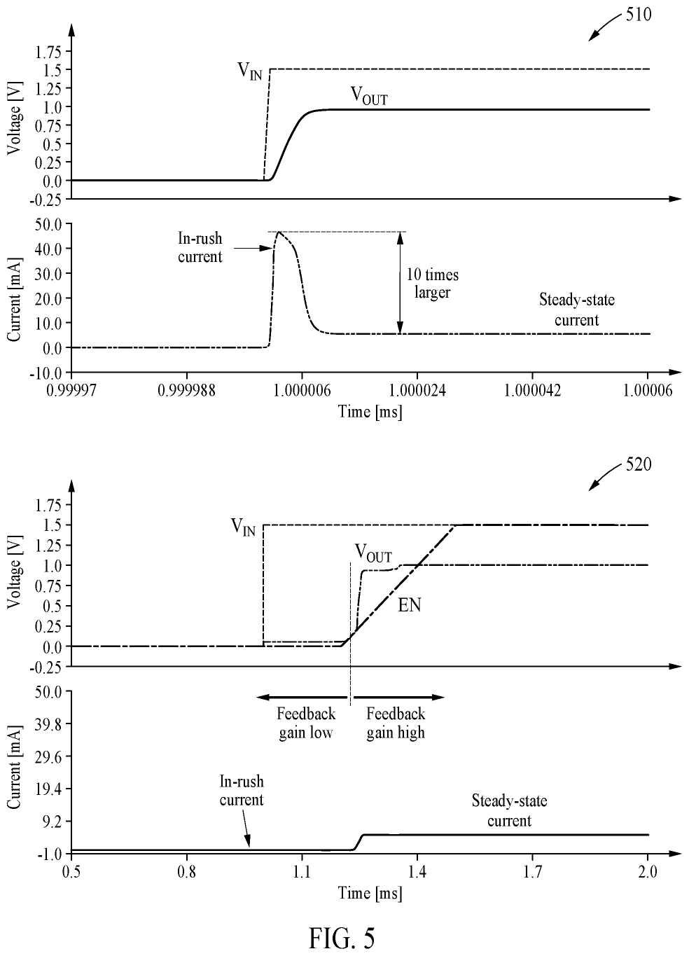

FIG. 5 is a diagram illustrating an example of a result of a simulation of a linear power regulator according to an example embodiment.

A linear power regulator used here may receive input power of 1.5 volts (V) and output 1.0V. In a steady or normal operation state, a load current may be 5 milliamperes (mA) and a load capacitance may be 100 picofarads (pF) to its maximum. Before the input power V_{IN} is applied, the linear power regulator may be in a state in which a voltage at both ends of a load capacitor is extremely low, for example, 0V.

As shown in a graph 510, when the input power V_{IN} is applied, a large inrush current may be input to a load capacitor for an existing linear power regulator to increase a voltage rapidly. In such a case, the inrush current input to the load capacitor may be approximately 10 times greater than the load current which is 5 mA in the steady operation state, and thus may result in a malfunction of a chip or damage to the chip in the long run.

In contrast, the linear power regulator 100 described herein may control a negative feedback coefficient to be less than a preset magnitude by the negative feedback coefficient controller 123 based on a control signal generated by the control signal generator 124. Thus, as shown in a graph 520, an inrush current input to a load capacitor may be smaller than the inrush current illustrated in the graph 510. Thus, it is possible to prevent a malfunction of a chip and damage to the chip that may occur as an excessive inrush current is input to a load capacitor. In addition, when a ramp signal-type control signal is transmitted from the control signal generator 124 to the negative feedback coefficient controller 123, a negative feedback coefficient may increase gradually, and accordingly, an output voltage V_{OUT} may increase gradually. Thus, a current may stably reach a steady-state load current without an additional inrush current.

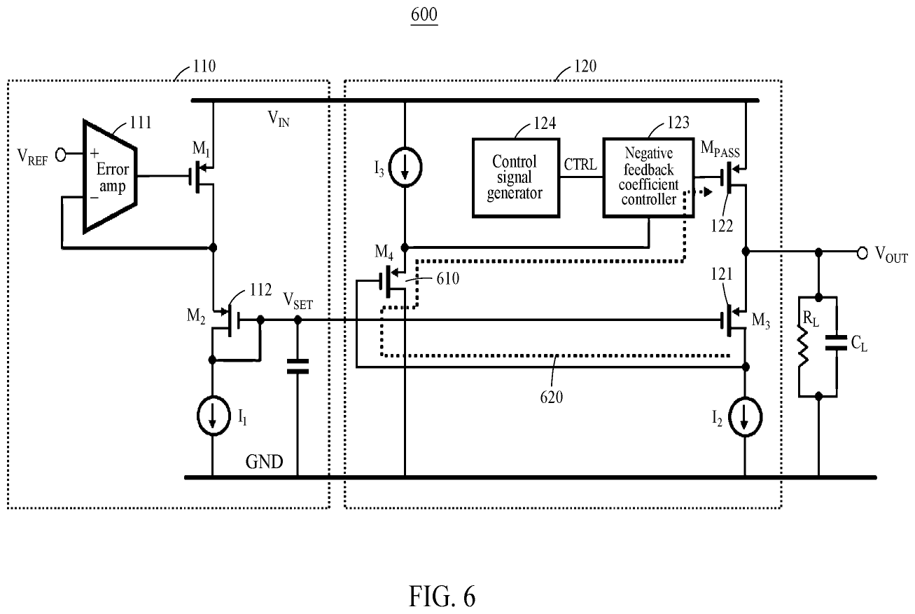

FIG. 6 is a diagram illustrating an example of a linear power regulator according to another example embodiment.

Referring to FIG. 6, a linear power regulator 600 includes a V_{SET} generating circuit 110, a source follower 121, a pass-transistor 122, and a control signal generator 124, which are the same components as described in FIG. 1, and thus a more detailed and repeated description of the components will be omitted here for brevity.

As illustrated in FIG. 6, the linear power regulator 600 includes an additional source follower 610 that is connected to a drain terminal of the source follower 121 and a gate of the pass-transistor 122 to form a negative feedback loop 620. The source follower 121 and the additional source follower 610 may also be defined as a first source follower and a second source follower, respectively.

The additional source follower 610 may provide a low impedance to a source terminal of the additional source follower 610 to allow a pole frequency exhibited at a gate end of the pass-transistor 122 to move to a higher frequency band.

That is, the linear power regulator 600 may move the pole frequency exhibited at the gate end of the pass-transistor 122 to the higher frequency band using the additional source follower 610, and may thus operate in a broader frequency band compared to a linear power regulator that does not include the additional source follower 620.

In this example, a negative feedback coefficient controller 123 may control a negative feedback coefficient of the negative feedback loop 620. According to an example, a position at which the negative feedback coefficient controller 123 is disposed may be a position in the negative feedback loop 620. For example, as illustrated in FIG. 6, the negative feedback coefficient controller 123 may be disposed between the additional source follower 610 and the pass-transistor 122.

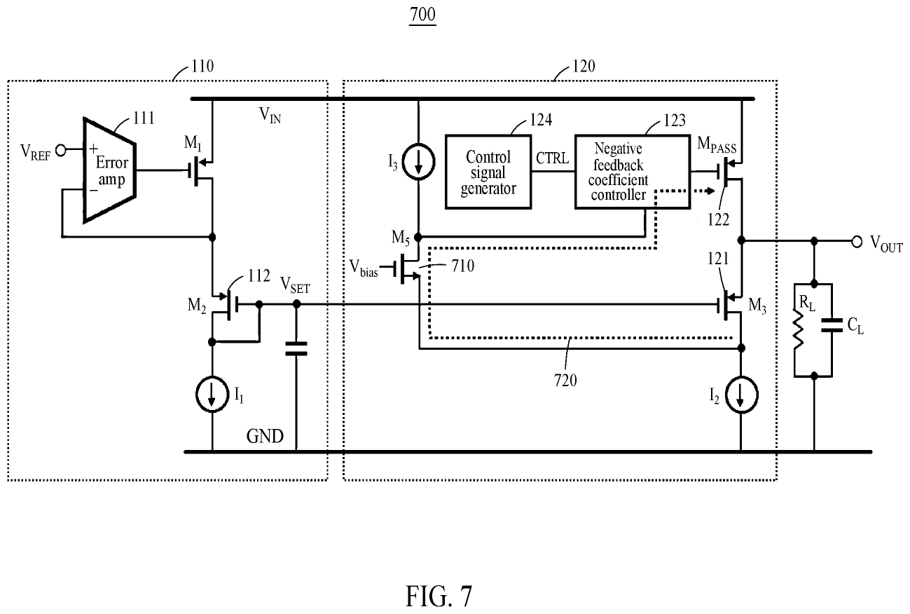

FIG. 7 is a diagram illustrating an example of a linear power regulator according to another example embodiment.

Referring to FIG. 7, a linear power regulator 700 includes a V_{SET} generating circuit 110, a source follower 121, a pass-transistor 122, and a control signal generator 124, which are the same components as described in FIG. 1, and thus a more detailed and repeated description of the components will be omitted here for brevity.

As illustrated in FIG. 7, the linear power regulator 700 includes a cascode transistor 710 that is connected to a drain terminal of the source follower 121 and a gate of the pass-transistor 122 to form a negative feedback loop 720.

The cascode transistor 710 may provide a low impedance to a source terminal of the cascode transistor 710 to allow a pole frequency of the drain terminal of the source follower 121 to move to a higher frequency band.

That is, the linear power regulator 700 may move the pole frequency of the drain terminal of the source follower 121 to the higher frequency band using the cascode transistor 710, and may thus operate in a broader frequency band compared to a linear power regulator that does not include the cascode transistor 710.

In addition, by the cascode transistor 710 of the linear power regulator 700, an impedance at a drain terminal of the cascode transistor 710 may increase more greatly than the linear power regulator that does not include the cascode transistor 710. Thus, the linear power regulator 700 may have an increased negative feedback gain compared to the linear power regulator that does not include the cascode transistor 710.

In this example, a negative feedback coefficient controller 123 may control a negative feedback coefficient of the negative feedback loop 720. According to an example, a position at which the negative feedback coefficient controller 123 is disposed may be a position in the negative feedback loop 720. For example, as illustrated in FIG. 7, the negative feedback coefficient controller 123 may be disposed between the cascode transistor 710 and the pass-transistor 122.

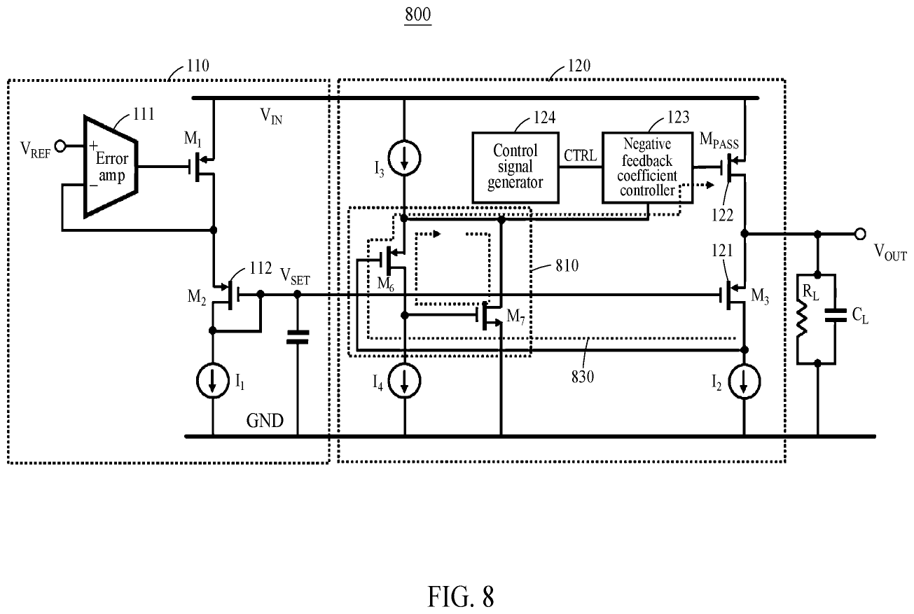

FIG. 8 is a diagram illustrating an example of a linear power regulator according to another example embodiment.

Referring to FIG. 8, a linear power regulator 800 includes a V_{SET} generating circuit 110, a source follower 121, a pass-transistor 122, and a control signal generator 124, which are the same components as described in FIG. 1, and thus a more detailed and repeated description of the components will be omitted here for brevity.

As illustrated in FIG. 8, the linear power regulator 800 includes a local negative feedback loop 810 including an additional source follower M₆ and a common source amplifier M₇, and a main negative feedback loop 830 formed by connecting a drain terminal of the source follower 121, a gate of the pass-transistor 122, and the local negative feedback loop 810. In such a case, by the local negative feedback loop 810, an impedance of a source terminal of the additional source follower M₆ may lower by a gain of the local negative feedback loop 810.

As the impedance of the source terminal of the additional source follower M₆ lowers by the gain of the local negative feedback loop 810, a pole frequency at a gate end of the pass-transistor 122 may move to a higher frequency band compared to a linear power regulator that does not include the local negative feedback loop 810. Thus, the linear power regulator 800 may operate in a broader frequency band compared to the linear power regulator that does not include the local negative feedback loop 810. The source follower 121 and the additional source follower M₆ may also be defined as a first source follower and a second source follower, respectively.

In this example, a negative feedback coefficient controller 123 may control a negative feedback coefficient of the main negative feedback loop 830. According to an example, a position at which the negative feedback coefficient controller 123 is disposed may be a position in the main negative feedback loop 830. For example, as illustrated in FIG. 8, the negative feedback coefficient controller 123 may be disposed between the local negative feedback loop 810 and the pass-transistor 122.

According to an example embodiment, it is possible to prevent a malfunction of a circuit and damage to the circuit by reducing an inrush current that flows in a pass-transistor and a load end when power is applied.

According to an example embodiment, it is possible to reduce an inrush current in a linear power regulator by controlling a negative feedback coefficient of the linear power regulator using a negative feedback coefficient controller of a simple structure, thereby minimizing the size of an area of a chip including the linear power regulator and enabling integration more effectively.

The foregoing detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A linear power regulator comprising:
a source follower configured to determine an output voltage of the linear power regulator based on a reference voltage signal applied from outside;
a pass-transistor connected to a source end of the source follower and configured to provide a current to a load of the linear power regulator;
a negative feedback loop formed by connecting a drain terminal of the source follower and a gate of the pass-transistor; and
a negative feedback coefficient controller disposed between the drain terminal of the source follower and the gate of the pass-transistor and configured to control a negative feedback coefficient of the negative feedback loop,
wherein the negative feedback coefficient controller is configured to change the negative feedback coefficient of the negative feedback loop based on an elapsed time from a point in time at which a power signal is applied to the linear power regulator.

2. The linear power regulator of claim 1, wherein the negative feedback coefficient controller is configured to control the negative feedback coefficient to be less than a steady-state negative feedback coefficient for a predetermined period of time from the point in time at which the power signal is applied to the linear power regulator.

3. The linear power regulator of claim 1, wherein the negative feedback coefficient controller comprises:
a transmission gate switch configured to be switched on or off based on a control signal and change an impedance at both ends of the transmission gate switch by being switched on or off to control the negative feedback coefficient.

4. The linear power regulator of claim 1, further comprising:
a control signal generator configured to receive the power signal that is applied or a driving signal that drives the linear power regulator, and output a control signal for controlling the negative feedback coefficient based on a point in time at which the power signal or the driving signal is received,
wherein the negative feedback coefficient controller is configured to control the negative feedback coefficient based on the control signal.

5. The linear power regulator of claim 4, wherein the control signal generator comprises:
a delay circuit configured to delay the power signal or the driving signal for a predetermined period of time, and then input the delayed power signal or the delayed driving signal to the negative feedback coefficient controller to control the negative feedback coefficient to be maintained less than a steady-state negative feedback coefficient for the predetermined period of time.

6. The linear power regulator of claim 4, wherein the control signal generator comprises:
a ramp generating circuit configured to generate a ramp signal-type control signal based on the driving signal,
wherein the ramp signal-type control signal controls the negative feedback coefficient to increase at a speed less than or equal to a preset speed.

7. The linear power regulator of claim 4, wherein the control signal generator comprises:
an input power-based ramp generating circuit configured to generate a control signal that increases at a speed less than or equal to a preset speed when the power signal is applied.

8. The linear power regulator of claim 7, wherein, when the driving signal is received, the input power-based ramp generating circuit is configured to convert the driving signal to the power signal by removing a switch for ENABLE from the driving signal.

9. A linear power regulator comprising:
a first source follower configured to determine an output voltage of the linear power regulator based on a reference voltage signal applied from outside;
a pass-transistor connected to a source end of the first source follower and configured to provide a current to a load of the linear power regulator;
a second source follower connected to a drain terminal of the first source follower and a gate of the pass-transistor to form a negative feedback loop; and
a negative feedback coefficient controller configured to control a negative feedback coefficient of the negative feedback loop,
wherein the negative feedback coefficient controller is configured to change the negative feedback coefficient of the negative feedback loop based on an elapsed time from a point in time at which a power signal is applied to the linear power regulator.

10. The linear power regulator of claim 9, wherein the negative feedback coefficient controller is configured to control the negative feedback coefficient to be less than a steady-state negative feedback coefficient for a predetermined period of time from the point in time at which the power signal is applied to the linear power regulator.

11. The linear power regulator of claim 9, wherein the negative feedback coefficient controller comprises:
a transmission gate switch configured to be switched on off based on a control signal, and change an impedance at both ends of the transmission gate switch by being switched on or off to control the negative feedback coefficient.

12. A linear power regulator comprising:
a source follower configured to determine an output voltage of the linear power regulator based on a reference voltage signal applied from outside;
a pass-transistor connected to a source end of the source follower and configured to provide a current to a load of the linear power regulator;
a cascode transistor connected to a drain terminal of the source follower and a gate of the pass-transistor to form a negative feedback loop; and
a negative feedback coefficient controller disposed between the cascode transistor and the pass-transistor and configured to control a negative feedback coefficient of the negative feedback loop,
wherein the negative feedback coefficient controller is configured to change the negative feedback coefficient of the negative feedback loop based on an elapsed time from a point in time at which a power signal is applied to the linear power regulator.

13. The linear power regulator of claim 12, wherein the negative feedback coefficient controller is configured to control the negative feedback coefficient to be less than a steady-state negative feedback coefficient for a predetermined period of time from the point in time at which the power signal is applied to the linear power regulator.

14. The linear power regulator of claim 12, wherein the negative feedback coefficient controller comprises:
a transmission gate switch configured to be switched on or off based on a control signal and change an impedance at both ends of the transmission gate switch by being switched on or off to control the negative feedback coefficient.
